(19) United States
(12) Patent Application Publication
(10) Pub. No.: US 2018/0336025 A1
(43) Pub. Date: Nov. 22, 2018

(54) VEHICLE-MOUNTED CONTROL SYSTEM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Tomohiro Taniguchi, Yokkaichi, Mie (JP); Shinya Itou, Yokkaichi, Mie (JP)

(73) Assignees: AutoNetworks Technologies, Ltd., Yokkaichi, Mie (JP); SUMITOMO ELECTRIC INDUSTRIES, LTD., Osaka-shi, Osaka (JP); Sumitomo Wiring Systems, Ltd., Yokkaichi, Mie (JP)

(21) Appl. No.: 15/777,697

(22) PCT Filed: Jan. 11, 2017
(86) PCT No.: PCT/JP2017/000552

§ 371 Date: May 21, 2018

(30) Foreign Application Priority Data
Jan. 14, 2016 (JP) 2016-005228

(51) Int. Cl. G06F 8/65

(52) U.S. Cl. CPC G06F 8/65; B60R 16/0231

(57) ABSTRACT

Provided is a technique for substantially increasing a transmission speed of an update program. ECUs serving as control apparatuses are vehicle-mounted, and operate based on an individually-provided programs that can be updated. An ECU serving as an update program transmission apparatus is vehicle-mounted and transmits an update program for updating the programs of the control apparatuses. A relay apparatus is vehicle-mounted, includes a relay device for relaying the update program, and is connected between the control apparatuses and the update program transmission apparatus. A transmission line transmits the update program transmitted from the update program transmission apparatus to the relay apparatus. A reception line is connected to the control apparatuses and receives the update program from the relay apparatus. A power supply line supplies power from a vehicle-mounted power source to the ECUs and transfers the update program from the update program transmission apparatus to the control apparatuses.

### CROSS-REFERENCE TO RELATED APPLICATIONS

This is application is the US national stage of PCT/JP2017/000552 filed Jan. 11, 2017 which claims priority of Japanese Application No. JP 2016-005228 filed Jan. 14, 2016.

### TECHNICAL FIELD

This invention relates to a vehicle-mounted control system, and in particular, a technique for updating a program for a control apparatus.

### BACKGROUND ART

For example, an ECU (electronic control unit) is known as a vehicle-mounted control apparatus. Also, an ECU functions based on a program, and a technique for updating the program is also known.

For example, JP 2013-57994A introduces a technique for updating a program via a gateway. Also, a method for improving the processing speed in the gateway in data transfer processing for this update has been proposed.

FIG. 4 is a schematic diagram showing conventional updating of a program. An ECU 30 has a function of updating programs for ECUs 31, 32, 33, . . . . A gateway 2 has a relay device 24 and relays transmission and reception of signals between signal lines 41 and 42. A program for updating (hereinafter referred to as “update program”) that is transmitted by the ECU 30 is transferred as a signal C4 to the ECUs 31, 32, 33, . . . via the signal line 41, the relay device 24, and the signal line 42.

FIG. 5 is a schematic diagram showing other conventional (e.g., see JP 2013-57994A) updating of a program. The gateway 2 includes a switch 25 connected in parallel to a relay device 24, and a signal C4 is transferred from a signal line 41 to a signal line 42 via the switch 25. Accordingly, the update program is transferred from the ECU 30 to the ECUs 31, 32, and 33 without being subjected to data transfer processing by the relay device 24, and the update program is transmitted in a shorter amount of time than with the technique shown in FIG. 4.

However, even with the technique shown in FIG. 5, the update program is transferred via the signal lines 41 and 42. For example, the transfer speed of CAN (controller area network) communication is 500 kbps at most, and the communication bandwidth that can actually be used is about half of that at most. Accordingly, in the case where only CAN communication is used, if the data capacity is large as with an update program for an ECU for engine control, for example, the amount of time needed for transfer thereof is several minutes in some cases.

For example, a case is envisioned in which an update program for 10 ECUs are stored using CAN communication. Since the bandwidth that can be used is approximately 500 kps/2=250 kps, assuming that the update program is transmitted to the 10 ECUs, the bandwidth that can be used for one ECU is approximately 250 kps/10=25 kps. If it is assumed that the memory region to be used for storage is 1 MB in an ECU that is to store an update program, the amount of time needed for the storage is 8388608 bits/25 kbps 330 seconds, and thus about five and a half minutes are needed.

Since the delay in the relay device 24 is about 20 μs, even if this amount of delay is avoided using the switch 25, this contributes little to reducing the amount of time needed for transmission of the update program. On the other hand, the speed at which the update program is transmitted in the signal lines 41 and 42 is slower than the processing speed when the ECUs 31, 32, and 33 store the update program. Accordingly, in order to shorten the amount of time needed to store the update program in the ECUs 31, 32, and 33, the update program is preferably transmitted at a high speed.

In view of this, the present invention aims to provide a technique for substantially increasing the transmission speed of the update program.

### SUMMARY

A vehicle-mounted control system includes: at least one control apparatus that is vehicle-mounted and is configured to operate based on an individually-provided program that can be updated; an update program transmission apparatus that is vehicle-mounted and is configured to transmit an update program for updating the program of the control apparatus; a relay apparatus that is connected between the control apparatus and the update program transmission apparatus, includes a relay device for relaying the program, and is vehicle-mounted; a transmission line for transmitting the update program transmitted from the update program transmission apparatus to the relay apparatus; a reception line that is connected to the control apparatus and is configured to receive the update program from the relay apparatus; a vehicle-mounted power source; and a power supply line for supplying power from the power source to the control apparatus and the update program transmission apparatus, and for performing transfer of the update program from the update program transmission apparatus to the control apparatus.

A vehicle-mounted control system substantially increases the transmission speed of an update program.

### BRIEF DESCRIPTION OF DRAWINGS

FIG. 1 is a schematic diagram illustrating a vehicle-mounted control system according to a first embodiment.

FIG. 2 is a schematic diagram showing a problem to be solved by a vehicle-mounted control system according to a second embodiment.

FIG. 3 is a schematic diagram illustrating the vehicle-mounted control system according to the second embodiment.

FIG. 4 is a schematic view showing a conventional technique.

FIG. 5 is a schematic view showing a conventional technique.

### DETAILED DESCRIPTION OF PREFERRED EMBODIMENTS

### First Embodiment

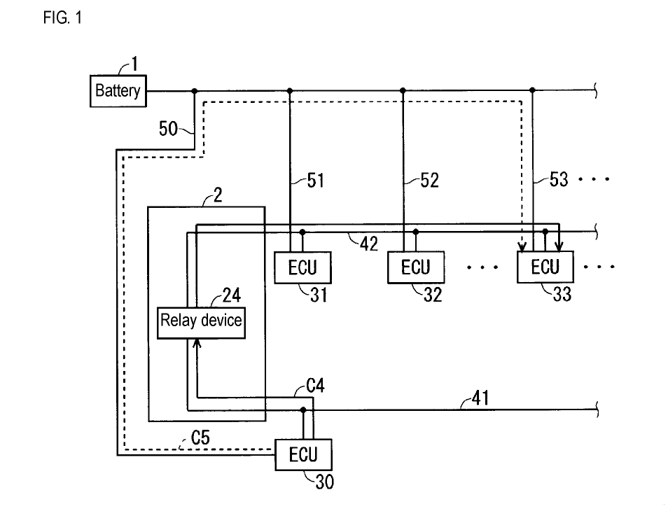

Hereinafter, a vehicle-mounted control system according to a first embodiment will be described. FIG. 1 is a schematic diagram illustrating a configuration of the vehicle-mounted control system.

The vehicle-mounted control system includes a power source 1 (denoted as “battery” in the drawing), a gateway 2, ECUs 30, 31, 32, 33, . . . , signal lines 41 and 42, and power supply lines 50, 51, 52, 53, . . . .

These constituent elements are vehicle-mounted, and the signal lines 41 and 42 and the power supply lines 50, 51, 52, 53, . . . are realized as a bundle of wires commonly known as a wire harness, for example.

The ECUs 31, 32, 33, . . . operate based on individually-provided programs. Also, the ECUs 31, 32, 33, . . . control various controlled apparatuses (e.g., vehicle-mounted loads such as an engine and a battery) (not shown in the drawing). Also, the programs can be updated. The ECU 30 functions as an update program transmission apparatus that transmits an update program for updating programs. The configurations and operations of the ECUs 30, 31, 32, 33, . . . are known techniques, and therefore detailed description thereof is omitted.

The gateway 2 is a relay apparatus that relays transmission and reception of signals. The gateway 2 includes a relay device 24, and the relay device 24 relays the update program from the ECU 30 to the ECUs 31, 32, 33, . . . . The signal line 41 functions as a transmission line that is connected to the ECU 30 and transmits the update program transmitted from the ECU 30. The signal line 42 functions as a reception line that is connected to the ECUs 31, 32, 33, . . . and receives the update program from the gateway 2. Here, the signal line 42 connects all of the ECUs 31, 32, 33, . . . .

The power supply lines 50, 51, 52, 53, . . . perform power supply from the power source 1 to the ECUs 30, 31, 32, 33, . . . (supply of an operation power source). Specifically, the power supply lines 50, 51, 52, 53, . . . supply power from the power source 1 to the respective ECUs 30, 31, 32, 33, . . . . Here, a case is illustrated in which power supply to all of the ECUs 30, 31, 32, 33, . . . is performed from the power source 1.

However, with the present embodiment, the power supply lines 50, 51, 52, 53, . . . also perform transfer of an update program from the ECU 30 to the ECUs 31, 32, 33, . . . . In other words, the power supply lines 50, 51, 52, 53, . . . are used in so-called PLC (power line communication).

In the present embodiment, the update program is transmitted in two parts, namely a signal C4 that uses the signal lines 41 and 42 and a signal C5 that uses the power supply lines 50, 51, 52, and 53. Accordingly, it is possible to substantially increase the transmission speed of the update program.

CAN communication can be used as the communication protocol for both of the signals C4 and C5. Accordingly, the communication speed (transmission speed) for transmitting the update program substantially doubles, and the amount of time needed for transmitting the update program is cut in half. The technique by which the ECUs 31, 32, 33, . . . construct the original update program based on the multiple signals C4 and C5 is known, and the processing speed needed to store the update program as described above is faster compared to the transmission speed. Accordingly, the amount of time needed for storing the update program can be shortened.

### Second Embodiment

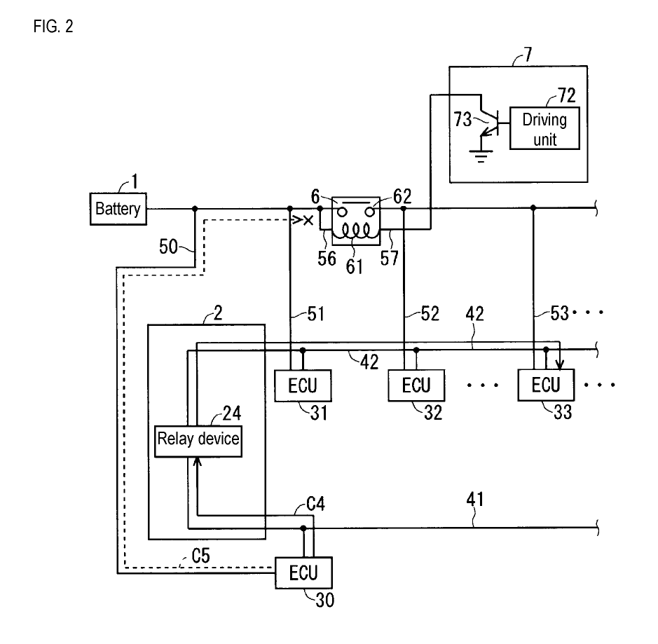

Hereinafter, a vehicle-mounted control system according to a second embodiment will be described. FIG. 2 is a schematic diagram for illustrating a problem to be solved by the second embodiment. The configuration shown in FIG. 2 shows a configuration obtained by adding an ignition relay 6 to the configuration of the vehicle-mounted control system shown in the first embodiment. Note that in the description of the present embodiment, constituent elements similar to those described in the first embodiment are denoted by identical reference numerals and description thereof is omitted.

The ignition relay 6 is a normally-open relay, and is closed by an ECU 7 for ignition (hereinafter referred to as “power source state transition ECU”). Specifically, the ignition relay 6 includes a coil 61 and a normally-off switch 62 that turns on (performs electrical conduction) due to current being applied to the coil 61.

In the power supply line, the switch 62 is provided between at least one of the ECUs 31, 32, 33, . . . and the power source 1. Here, a case of being provided on a power supply line between the ECU 31 and the ECUs 32 and 33 will be illustrated.

The coil 61 includes one end 56 that is connected to the power source 1, and another end 57. The other end 57 is connected to the power source state transition ECU 7. Specifically, the power source state transition ECU 7 includes a driving unit 72 that starts the ignition and a transistor 73 for switching, and the transistor 73 is provided in the power source state transition ECU 7 with an open collector and a grounded emitter. Also, the other end 57 is connected to the collector of the transistor 73.

The driving unit 72 receives an instruction to start ignition using a known technique, and supplies a current to the base of the transistor 73. Accordingly, the transistor 73 turns on, and current flows in the coil 61 between the power source 1 and the emitter of the transistor 73. In this manner, due to the operation of the power source state transition ECU 7, current is applied to the coil 61, the switch 62 performs electrical conduction, the ECUs 32 and 33 are supplied with power, and ignition is started.

Due to the ignition relay 6 being provided in the power supply line in this manner, some of the ECUs, in this example, the ECUs 32 and 33, are not supplied with power when the ignition relay 6 is turned off.

Normally, the programs are updated when the vehicle is stopped, and therefore the programs are updated in an ignition-off state, that is, a state in which the switch 62 is off. Accordingly, if PLC is performed as in the first embodiment, the signal C5 cannot be transmitted in the power supply lines 52 and 53 to the ECUs 32 and 33. In this case, transmission of the update program to the ECUs 32 and 33 depends only on the signal C4, similarly to the conventional technique. With this, the transmission speed of the update program cannot be substantially increased.

The second embodiment gives consideration to the existence of the ignition relay 6 and presents a technique in which the power supply lines 52 and 53 are used for PLC even though the ignition relay 6 is present.

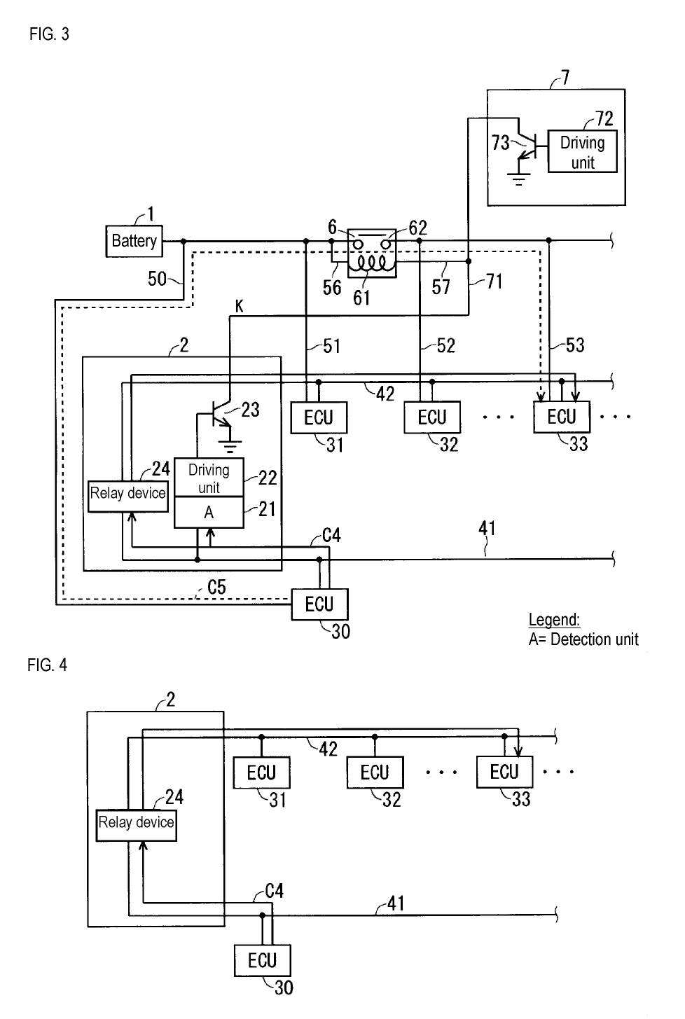

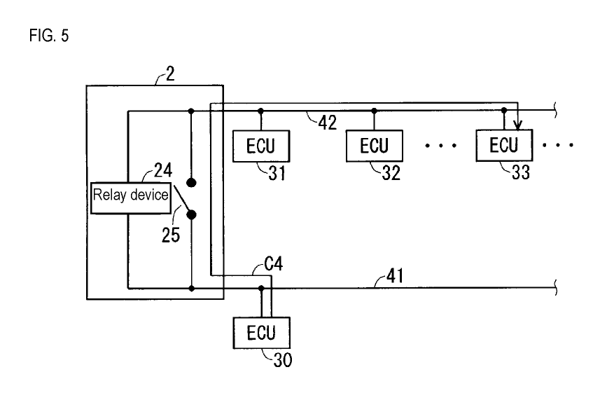

FIG. 3 is a schematic diagram illustrating a configuration of the second embodiment. The configuration shown in FIG. 2 shows a configuration obtained by adding an ignition relay 6 to the configuration of the vehicle-mounted control system shown in the first embodiment.

The second embodiment has a configuration obtained by adding a driving line 71 that is connected to the other end 57 of the coil 61 to the gateway 2 of the first embodiment. A driving signal K is output to the driving line 71. When transmission of an update program from the ECU 30 is detected, the driving signal K causes the switch 62 to perform electrical conduction.

More specifically, in the present embodiment, the gateway 2 further includes a detection unit 21, a driving unit 22, and a transistor 23 for switching. The detection unit 21 is connected to the signal line 41 and detects transmission of an update program from the ECU 30. Due to the detection unit 21 detecting the transmission, the driving unit 22 turns on the transistor 23. The collector of the transistor 23 is connected to the driving line 71, and the emitter is grounded, and therefore the driving signal K reaches the ground potential due to the transistor 23 turning on. Here, this state of being at the ground potential is thought of as a state in which the driving signal K is active.

Due to the activation of the driving signal K, current flows in the coil 61 between the power source 1 and the emitter of the transistor 23. Thus, transmission of the update program triggers application of a current to the coil 61, electrical conduction of the switch 62, and transfer of the signal C5 to the ECUs 32 and 33. Accordingly, the amount of time needed to store the update program can be shortened, similarly to the first embodiment.

### MODIFIED EXAMPLE

There is no need to use the same communication protocol for the signals C4 and C5. Of course, a communication protocol that is faster than CAN communication (e.g., Ethernet (registered trademark)) can be employed as the communication protocol for the signals C4 and C5.

Also, in the second embodiment, the transistor 73 may be turned on by the driving unit 72 using the driving signal K. Also, the ignition relay 6 may be opened (i.e., the switch 62 may be turned off) by the detection unit 21 detecting that transmission of the update program has ended and making the driving signal K inactive.

The configurations described in the embodiments and modified examples can be combined as appropriate, as long as they do not contradict each other.

Although the invention has been described in detail in the description above, the above description is in all ways exemplary and the present invention is not limited thereto. It is understood that infinite modified examples that have not been illustrated can be envisioned without departing from the scope of the invention.

1. A vehicle-mounted control system, comprising:
at least one control apparatus that is vehicle-mounted and is configured to operate based on an individually-provided program that can be updated;
an update program transmission apparatus that is vehicle-mounted and is configured to transmit an update program for updating the program of the control apparatus;
a relay apparatus that is connected between the control apparatus and the update program transmission apparatus, includes a relay device for relaying the program, and is vehicle-mounted;
a transmission line for transmitting the update program transmitted from the update program transmission apparatus to the relay apparatus;
a reception line that is connected to the control apparatus and is configured to receive the update program from the relay apparatus;
a vehicle-mounted power source; and
a power supply line for supplying power from the power source to the control apparatus and the update program transmission apparatus, and for performing transfer of the update program from the update program transmission apparatus to the control apparatus.

2. The vehicle-mounted control system according to claim 1, further comprising
a normally-off switch that is provided between at least one said control apparatus and the power source in the power supply line,
wherein the relay apparatus further includes
a driving line for outputting a driving signal that causes the switch to perform electrical conduction when transmission of the update program from the update program transmission apparatus is detected.

3. The vehicle-mounted control system according to claim 2, further comprising
a coil including one end connected to the power source and another end connected to the driving line,
wherein the switch performs electrical conduction due to application of current to the coil, and current is applied to the coil due to the driving signal becoming active.
